(19) United States
(12) Patent Application Publication
(10) Pub. No.: US 2006/0294556 A1
(43) Pub. Date: Dec. 28, 2006

(54) METHOD FOR MULTIMEDIA PROCESSING IN A COMPUTER SYSTEM AND RELATED DEVICE

(76) Inventors: Wen-Chi Chen, Taipei Hsien (TW); Chung-Wen Chen, Taipei Hsien (TW); Chung-Wei Chiu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,519

(22) Filed: Jun. 28, 2005

(51) Int. Cl. H04N 7/173; H04N 7/16

(52) U.S. Cl. 725/89; 725/88; 725/102; 725/134; 725/142

(57) ABSTRACT

A computer system includes a multimedia processing unit and an access device. The access device is used for loading a video signal of a storage medium. When the computer system is powered off and a multimedia mode is entered, the multimedia processing unit detects whether the storage medium is connected to the access device. If the storage medium is connected to the access device, the multimedia processing unit processes the video signal.

### BACKGROUND OF THE INVENTION

1. Field of the Invention

The present invention relates to a multimedia computer system, and more particularly, to a computer system capable of playing multimedia and storing video data.

2. Description of the Prior Art

Since electronics technology has progressed, electronic devices, such as personal computers, notebook computers, and personal data assistants, have become available to everyone. In addition to data management, such devices also allow access to the Internet and can serve audio and video entertainment, adding more fun to a busy life.

For audio and video entertainment, CD-ROM, DVD-ROM, or CD-RW implemented in a computer system are commonly used for playing video multimedia, such as VCDs and DVDs. After the operating system of the computer is loaded, a user can enjoy the video and audio via the display and the speaker of the computer. However, the power supply of the computer system only provides power to the optical disk drive after the computer system is booted, and only then the optical disk drive is capable of being operated. If the computer system is powered off, the optical disk drive does not work. Therefore, the computer system must be powered on before playing video multimedia. The lengthy duration of the booting process for the operating system renders playing video multimedia undesirable.

Regarding an optical disk drive capable of being operated when the computer is powered off, U.S. Pat. No. 6,266,714 teaches such a system. This patent discloses a computer system capable of playing audio CDs in a CD-ROM drive without waiting for the lengthy duration of the boot process of the operating system, and a control method for operating the optical disk drive when the computer is powered off.

However, without booting the computer, current computer systems cannot receive, convert to digital, and store unformatted data from external microphones or video sources, nor can they receive and automatically play multimedia files from an external storage device (such as a card reader).

### SUMMARY OF THE INVENTION

It is therefore a primary objective of the claimed invention to provide a computer system and related method to solve the above-mentioned problem. Without booting the computer, the claimed invention can receive, convert to digital, and store unformatted data from an external video/audio input device, or receive and automatically play multimedia files from a storage device.

The claimed invention provides a method for multimedia processing in a computer system. The computer system comprises a multimedia processing unit and an access device for loading a video signal of a storage medium. The multimedia processing unit is capable of entering a multimedia mode when the computer system is powered off. The method comprises determining whether the multimedia mode is entered, determining whether the computer system is powered off, detecting whether the storage medium is connected to the access device if the computer system is powered off, and enabling the multimedia processing unit to process the video signal in the multimedia mode when the storage medium is connected to the access device.

The claimed invention also provides a method for multimedia processing in a computer system. The computer system is capable of loading an unformatted video signal from a video/audio input device. The method comprises determining whether a multimedia mode is entered, determining whether the computer system is powered off, detecting whether the unformatted video signal is input if the computer system is powered off, and enabling the multimedia processing unit to process the video signal in the multimedia mode when the unformatted video signal is input.

The claimed invention provides a computer system. A video/audio input device operates with the computer system for inputting an unformatted video signal. The computer system comprises a central processing unit, a multimedia processing unit, a switch circuit, and a display control unit.

When the computer system is powered on, the central processing unit enters a computer mode and outputs a host signal. The multimedia processing unit is capable of transforming an unformatted video signal into a multimedia signal formatted for playing when the computer system is powered off and the multimedia mode is entered. The switch circuit is electrically connected to the central processing unit and the multimedia processing unit for switching between the computer mode and the multimedia mode. The display control unit is electrically connected to the central processing unit and the multimedia processing unit for receiving the host signal or the multimedia signal and properly scaling the received signal for playing.

When the computer system is powered off and the multimedia mode is entered, the switch circuit is switched into the multimedia mode. The multimedia processing unit detects the unformatted video signal input by the video/audio input device and processes the unformatted video signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a computer system capable of automatically playing multimedia according to the present invention.

FIG. 2 is a flowchart of multimedia process of the computer system according to the present invention.

### DETAILED DESCRIPTION

Regarding the above description and the detailed technology of the present invention, a best embodiment with drawings are disclosed as follows.

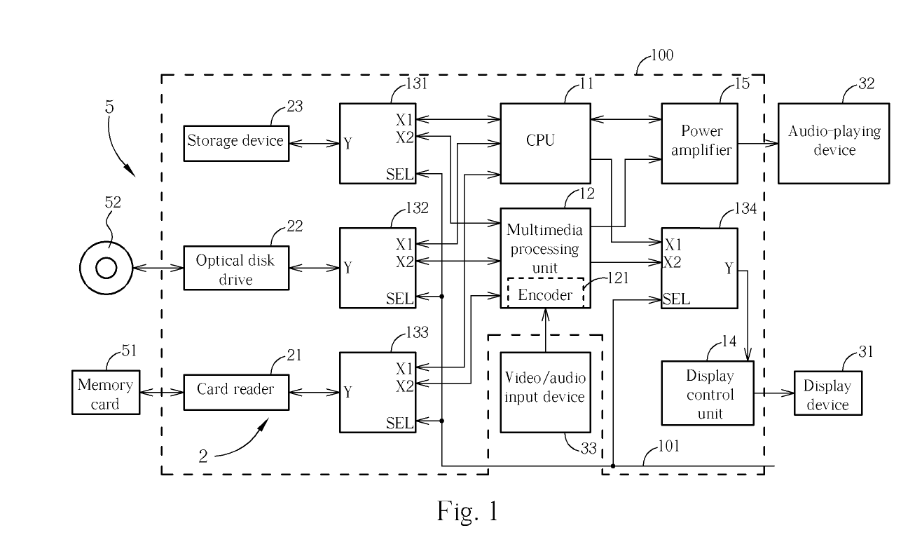

FIG. 1 is a diagram of a computer system 100 capable of automatically playing multimedia according to the present invention. The computer system 100 is connected to a display device 31, an audio-playing device 32, and a video/audio input device 33 (the details of which are described later).

In this embodiment, the display device 31 is a liquid crystal display (LCD). The audio-playing device 32 is a speaker. The video/audio input device 33 is a device, such as a microphone and a digital video camera, capable of receiving or recording video and audio signals and inputting unformatted video and audio data into the computer system 100.

The computer system 100 comprises a central processing unit 11, a multimedia processing unit 12, a plurality of switch circuits 131˜134, a display control unit 14, and a power amplifier 15. In addition, the computer system 100 further comprises an access device 2 capable of loading video data from a storage medium 5.

Note that the central processing unit 11 and the multimedia processing unit 12 have their own power sources. There are control buttons (not shown) set for different modes. When a control button is pressed, power is supplied correspondingly so as to select a computer mode or a multimedia mode for operation.

Additionally, the priority of the operation is set to the computer mode. When the computer system 100 is in the computer mode and the control button for the multimedia mode is pressed unexpectedly, the multimedia mode will not be entered. However, when in the multimedia mode and the control button for the computer mode is pressed unexpectedly, the computer system 100 will enter the computer mode.

In this embodiment, the display control unit 14 scales the received signals properly and outputs the scaled signals to the external display device 31. The power amplifier 15, electrically connected to the central processing unit 11 and the multimedia processing unit 12, is used for amplifying component audio signals of video signals, and then the external audio-playing device 32 plays the audio signals.

The access device 22 includes a card reader 21, an optical disk drive 22, and a storage device 23. The storage medium 5 accessed by the card reader 21 is a memory card 51, and the storage medium 5 accessed by the optical disk drive 22 is a video optical disk 52. The storage device 23 is a hard disk. As known in the art, the access device 2 can be a high-speed transmitting interface, such as a USB interface, and the storage medium 5 can be a portable storage device, such as a USB mass storage device.

When the computer system 100 is booted, the central processing unit 11 enters the computer mode and outputs a host signal. On the contrary, when the computer system 100 is powered off, the multimedia processing unit 12 is capable of entering the multimedia mode and transforming an unformatted video signal of the video/audio input device 33 into a multimedia signal formatted for playing. Additionally, the multimedia processing unit 12 comprises an encoder 121 for performing an analog/digital transformation on the unformatted video signal, so that the input signal becomes the multimedia signal in digital format.

When the computer system 100 is powered off and the multimedia processing unit 12 detects the unformatted video signal from the video/audio input device 33, the multimedia mode is entered so that the switch circuit 134 enables the display device 31 to play video. If the user decides to store the input video data, the video data is stored in the storage device 23 of the computer system 100.

Similarly, when the computer system 100 is powered off, the multimedia processing unit 12 is capable of determining whether the storage medium 5 is connected to the access device 2. If the storage medium 5 is connected to the access device 2, the multimedia mode is entered to play the video data from the storage medium 5.

The switch circuits 131˜134 are electrically connected to the central processing unit 11 and the multimedia processing unit 12, and include an integrated circuit (IC) or a plurality of MOSFET circuits. These switch circuits 131˜134 receive a select signal 101 to set the operation mode accordingly. The select signal 101 is generated when the user presses external buttons (not shown) of the computer system 100 or operates a remote control. Another method is to use an on-screen display (OSD) function to show a list of functions on the display device 31, such that the select signal 101 can be generated accordingly.

When the computer system 100 is powered on, the computer mode is entered by the setting of the switch circuits 131˜134. That is, in the switch circuits 131˜134, node X1 is connected to node Y. Therefore, all commands are sent and controlled by the central processing unit 11. However, when the computer system 100 is powered off and the user presses the button or operates the remote control to enter the multimedia mode, node X2 is connected to node Y. Therefore, when the computer system 100 is powered off, the multimedia processing unit 12 manages the processing of video signals and plays video.

No matter whether the computer system is powered on or off, the switch circuits 131˜133 can respectively access the storage device 23, the optical disk drive 22, and the card reader 21 because each switch circuit is connected to a respective access device. The switch circuit 134 is electrically connected to the display control unit 14, and transmits the host signal or the multimedia signal to the display control unit 14. The display control unit 14 scales the received signal properly for output to the external display device 31.

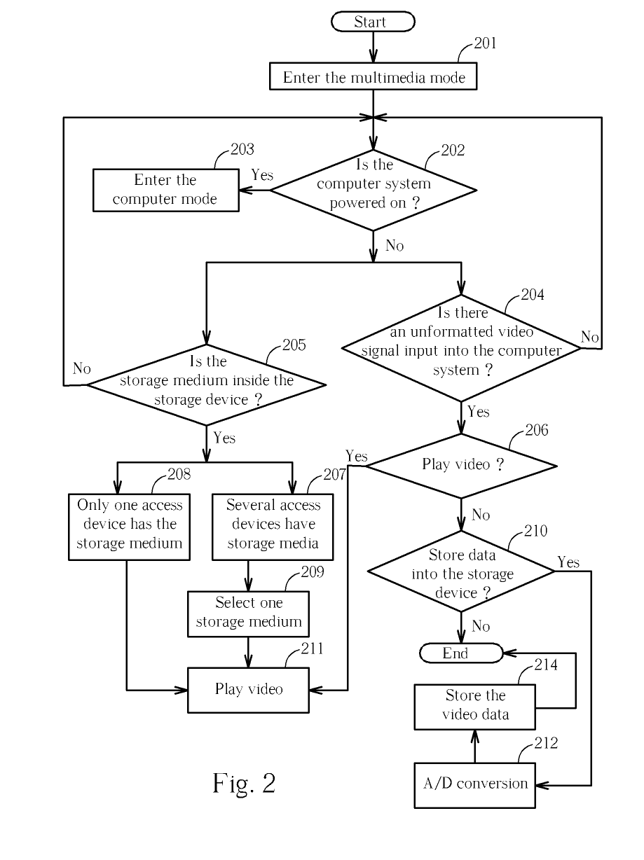

Please refer to FIG. 2, which is a flowchart of the multimedia process of the computer system 100. The steps are as follows.

First, the user presses a button or operates a remote control to enter the multimedia mode (step 201). Next, whether the computer system 100 is powered on is detected (step 202). If the computer system 100 is powered on, the computer mode is entered (step 203). If the computer system 100 is powered off, steps 204 and 205 are performed. That is, whether an unformatted video signal is input into the computer system 100 is detected (step 204), and whether the storage medium 5 is connected to the access device 2 is detected (step 205). There are two situations after steps 204 and 205.

Situation 1: If the detecting result is that the storage medium 5 is connected to the access device 2 (step 205), the computer system 100 can automatically determine there is one or more access device 2 available to read data from the storage medium 5. If, for example, there is one memory card 51 connected to the card reader 21, the computer system 100 detects that there is only one access device 2 available (step 208), and then the multimedia processing unit 12 enters the multimedia mode to load video signals from the memory card 51 for playing (step 211).

If the computer system 100 detects that there are more than one access devices 2 available, the computer system 100 continues detecting if each access device 2 has a storage medium 5 accessible to load the video signal. For instance, a memory card 51 is detected inside the card reader 21, and a video optical disk 52 is detected inside the optical disk drive 22. If there are several access devices 2 having a storage medium 5 accessible to load a video signal (step 207), the display device 31 shows states of each storage medium 5 to the user to select one of them as the multimedia source (step 209). Supposing that the video optical disk 52 is selected, the multimedia processing unit 12 enters the multimedia mode to play video signals loaded from the video optical disk 52 (step 211).

Situation 2: Suppose that the video/audio input device 33 inputs an unformatted video signal into the computer system 100 (step 204). If the user decides to directly play the video signal (step 206), the multimedia processing unit 12 enters the multimedia mode to automatically play the loaded video signal (step 211). Next, the computer system 100 determines whether the user wants to store the video data in the storage device 23 (step 210). If the user wants to store the video data in the storage device 23, the encoder 121 of the multimedia processing unit 12 performs an A/D conversion on the video data (step 212), so that the input video data can be stored in the storage device 23 (step 214).

In summary, the computer system 100 of the present invention and related method has the following advantages:

1. The user does not have to endure the lengthy booting process for the operating system and the subsequent execution of a multimedia program. When the computer is powered off, the present invention not only detects which access device has the storage medium 5 accessible for playing, but also automatically plays the multimedia file, saving the user a lot of time.

2. In the prior art, loading files from the video/audio input device 33, such as a microphone and a digital video camera, requires booting the computer system 100 and executing a loading program, which is undesirable. However, without booting the computer, the present invention can detect the unformatted signal from the video/audio input device 33 and transform the unformatted data into digital data by performing A/D conversion. Then, the present invention can store the digital data in the storage device 23 of the computer system 100 or play the video depending on the user's preference. The present invention provides the user with an easy way to play video and saves a lot of time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for multimedia processing in a computer system, the computer system comprising a multimedia processing unit capable of entering a multimedia mode when the computer system is powered off, and an access device for loading a video signal of a storage medium, the method comprising:
(a) determining whether the multimedia mode is entered;
(b) determining whether the computer system is powered off, and if the computer system is powered off, detecting whether the storage medium is connected to the access device; and
(c) enabling the multimedia processing unit to process the video signal in the multimedia mode when the storage medium is connected to the access device.

2. The method of claim 1 wherein processing the video signal comprises automatically playing the video signal loaded from the storage medium.

3. The method of claim 1 wherein the computer system comprises a plurality of access devices, and step (b) further comprises detecting which access device has a storage medium accessible to load the video signal.

4. The method of claim 3 wherein step (b) further comprises selecting one storage medium for playing video according to the detecting result.

5. A method for multimedia processing in a computer system, the computer system capable of loading an unformatted video signal from a video/audio input device, the method comprising:
(a) determining whether a multimedia mode is entered;
(b) determining whether the computer system is powered off, and if the computer system is powered off, detecting whether the unformatted video signal is input; and
(c) enabling the multimedia processing unit to process the video signal in the multimedia mode when the unformatted video signal is input.

6. The method of claim 5 wherein processing the video signal comprises automatically playing the video signal loaded from the video/audio input device.

7. The method of claim 5 wherein processing the video signal comprises:
(d) determining whether to store the video signal into the storage device of the computer system when the unformatted video signal is input; and
(e) storing the input video signal in the storage device of the computer system.

8. The method of claim 7 wherein step (i) further comprises performing an A/D conversion on the video signal.

9. A computer system capable of automatically playing multimedia content, a video/audio input device operating with the computer system for providing an unformatted video signal, the computer system comprising:
a central processing unit capable of entering a computer mode and outputting a host signal when the computer system is powered on;
a multimedia processing unit capable of entering a multimedia mode and transforming the unformatted video signal into a multimedia signal formatted for playing when the computer system is powered off;
a first switch circuit electrically connected to the central processing unit and the multimedia processing unit for switching the computer mode and the multimedia mode; and
a display control unit electrically connected to the central processing unit and the multimedia processing unit for receiving the host signal or the multimedia signal and scaling the received signal;
wherein when the computer system is powered off and the multimedia mode is entered, the first switch circuit is switched into the multimedia mode, and the multimedia processing unit detects the unformatted video signal inputted by the video/audio input device and processes the video signal.

10. The computer system of claim 9 further comprising:
an access device for loading a video signal from a storage medium; and
a second switch circuit electrically connected to the access device, the central processing unit, and the multimedia processing unit;
wherein when the computer system is powered off and the multimedia mode is entered, the multimedia processing unit determines whether the storage medium is connected to the access device, and if the storage medium is connected to the access device, the video signal is loaded from the storage medium and is played.

11. The computer system of claim 10 wherein the access device is a card reader, and the storage medium is a memory card.

12. The computer system of claim 10 wherein the access device is an optical disk drive, and the storage medium is an optical disk.

13. The computer system of claim 9 further comprising:
a storage device; and
a third switch circuit electrically connected to the storage device, the central processing unit, and the multimedia processing unit;
wherein when the computer system is powered off and the multimedia mode is entered, the multimedia processing unit is capable of detecting whether the unformatted video signal is input, and when determining to store the input video data, the input video data is stored in the storage device of the computer system.

14. The computer system of claim 9 wherein the multimedia processing unit comprises an encoder for transforming the unformatted video signal into the multimedia signal in digital format by performing an A/D conversion.

15. The computer system of claim 9 further comprising a power amplifier electrically connected to the central processing unit and the multimedia processing unit for amplifying an audio signal of the video signal output to an external audio-playing device for playing.
